(19) United States
(12) Patent Application Publication
(10) Pub. No.: US 2020/0337310 A1
(43) Pub. Date: Oct. 29, 2020

(54) Herbicidal Combinations

(71) Applicant: UPL LTD, Haldia (IN)

(72) Inventors: Jaidev Rajnikant Shroff, Dubai (AE); Vikram Rajnikant Shroff, Dubai (AE); Joaquim Ribeiro da Cunha, Sao Paulo (BR); Carlos Eduardo Fabri, Sao Paulo (BR); Sergio Tadeu Decaro Junior, Sao Paulo (BR); Ferdinando Marcos Lima Silva, Sao Paulo (BR); Luciano Zanotto Hohmann, Sao Paulo (BR)

(21) Appl. No.: 16/962,328

(22) PCT Filed: Dec. 28, 2018
(86) PCT No.: PCT/IB2018/060690

§ 371 Date: Jul. 15, 2020

(30) Foreign Application Priority Data
Jan. 17, 2018 (IN) 201831001974

(51) Int. Cl. A01N 43/653; A01N 25/14; A01N 25/04; A01N 43/48; A01N 57/30; A01N 57/04; A01N 57/20

(52) U.S. Cl. CPC A01N 43/653; A01N 25/14; A01N 25/04; A01N 57/20; A01N 57/30; A01N 57/04; A01N 43/48

(57) ABSTRACT

Disclosed herein is a herbicidal combination comprising a) carfentrazone ethyl; b) an organophosphorus herbicide and c) an imidazolinone herbicide

### TECHNICAL FIELD

The present invention relates to a herbicidal combination for controlling undesirable plants. The present invention more specifically relates to a synergistic combination of herbicides for controlling weeds.

### BACKGROUND AND PRIOR ART

Crop protection requires constant monitoring of the sown crop for various pests. Weeds are a persistent problem that need constant monitoring. Agriculturalist usually control or supress weed growth by using herbicides at either the pre-plant stages or after sowing or both depending on the weed type and the level of infestation.

Current practices include combining herbicides that have different modes of action, which allows for broader spectrum of control and allow for resistance management. The combinations used currently do not effectively handle resistant and persistent weeds. There is therefore a need in the art for improved combinations with enhanced efficacy and broader spectrum of weed control.

PPO inhibitor herbicides are mostly used to control broadleaf plants and have some activity on grasses. They have a limited translocation in plants and are used to control weeds in field crops, vegetables, tree fruits and vines, small fruits, nurseries, lawns, etc. PPO inhibitors usually burn plant tissues within hours or days of exposure, making them an excellent tool to control unwanted weeds both pre and post emergent.

Carfentrazone-ethyl is PPO inhibitor herbicide that is used for post-emergence use to control a wide range of broad-leaved weeds and for foliage desiccation. Combination of carfentrazone ethyl with other broad spectrum herbicides are known from WO2000008936A1 (Hakker et.al) or WO2017153221A1 (Scott). Hakker et al teach a combination comprising glufosinate, glyphosate, or an imidazolinone herbicide and a second herbicide such as carfentrazone-ethyl. Scott teaches a combination comprising carfentrazone ethyl and a mixed heptanoate-octanoate ester of bromoxynil.

Application of glutamine synthetase inhibitor herbicide Glufosinate results in a build-up of ammonia in the thylakoid lumen, leading to the uncoupling of photophosphorylation, which causes the production of reactive oxygen species, lipid peroxidation, and membrane destruction. Absorbed by the foliage of the plant, Glufosinate is an excellent tool for resistance management. It is mainly used for post-emergent control of weeds and grass weeds.

Imazethapyr belongs to the imidazolinone class of compounds and acts by inhibiting the Acetolactate Synthase (ALS) enzyme. This leads to disruption of the DNA synthesis and cell growth. It is a broad spectrum herbicide which controls broad leaved weeds as well as grasses. It is taken up by the weeds through roots and leaves. It has excellent residual action making it a good tool to be used for resistance management.

Combinations of herbicides are used to control a broader range of weeds. However, the combination of herbicides may not always result in the desired effect. Combination of herbicides may lead to an additive effect or an antagonistic effect. It may also result in phytotoxicity to the crops making it an undesirable combination. Agronomists must therefore, carefully select the herbicides that can be combined to offer a synergistic effect that would control weeds while having no phytotoxic effect on the crop, and reduce the chances of development of herbicide resistant weeds.

Protection of planted crops from undesirable plants which inhibit crop growth is a perpetual struggle for all farmers. Herbicides have been used to control growth of such plants. There are many herbicides and combinations known in the art. There remains a need for improved herbicidal combinations that can effectively control weeds thereby improving yield and plant health, with reduced phytotoxicity.

Another major issue farmers face are increasingly complex weed combinations. These weeds might not be controlled with double combinations of herbicides, let alone a single broad spectrum herbicide such as glyphosate. This is particularly true for farmers who have a crop that was harvested earlier than normal, if the fall weather is mild, weeds may germinate later in the season and on maturity produce more seed leading to a wider infestation. There is need in the art for a combination that can control a broad spectrum of weeds specifically in pre-plant burndown that allows for a good residual control.

Carfentrazone ethyl is a PPO inhibitor herbicide. Its chemical name is ethyl (RS)-2-chloro-3-{2-chloro-5-[4-(difluoromethyl)-4,5-dihydro-3-methyl-5-oxo-1H-1,2,4-triazol-1-yl]-4-fluorophenyl}propionate and has the chemical structure:

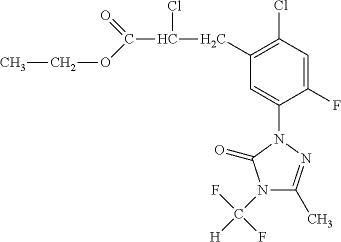 [SMILES: CCOC(=O)C(Cl)Cc1cc(-n2nc(C)n(C(F)F)c2=O)c(F)cc1Cl]

Glufosinate is a Glutamine synthetase inhibitor herbicide. Its chemical name is (2RS)-2-amino-4-[hydroxy(methyl)phosphinoyl]butyric acid and has the chemical structure:

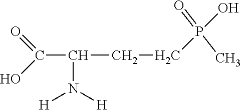

Imazathapyr is an imidazolinone herbicide. Its chemical name is 5-ethyl-2-[(RS)-4-isopropyl-4-methyl-5-oxo-2-imidazolin-2-yl]nicotinic acid and has the structure:

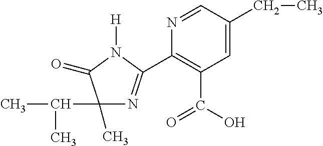 [SMILES: CCc1cnc(C2=NC(C)(C(C)C)C(=O)N2)c(C(=O)O)c1]

Carfentrazone alone is usually effective for control of early season broadleaf weed control. However, carfentrazone-ethyl has negligible activity on grasses. There is therefore, a need in the art, for an herbicidal combination which offers a broader spectrum of weed control, which can gives near complete control of weeds at lower use rates, and which gives good residual control.

There is therefore a need in the art for combinations that have advantageous properties such as a herbicidal combination that is synergistic, helps in resistance management, reduces dosage of herbicides used thus causing minimal damage to the environment, a herbicidal combination that has excellent residual effects.

Embodiments of the present invention may therefore ameliorate one or more of the above-mentioned problems:

### OBJECTS OF THE INVENTION

Therefore, one object of the present invention is to provide a synergistic herbicidal combination.

Another object of the present invention is to provide a method of controlling weeds at a locus by application of a synergistic herbicidal combination.

Another object of the present invention is to provide a composition comprising a synergistic herbicidal combination.

Yet another object of the present invention is to provide a method of increasing yield in a crop by application of a synergistic herbicidal combination.

Another object of the present invention is to provide a method of improving the plant health by application of a synergistic herbicidal combination.

Another object of the present invention is to provide a synergistic herbicidal combination which offers a broader and more complete spectrum of weed control.

Another object of the present invention is to provide a synergistic herbicidal combination which provides a better control of weeds at lower use rates, and which gives good residual control.

Another object of the present invention is to provide a synergistic herbicidal combination which is synergistic and thus helps in resistance management.

Some or all these and other objects of the invention can be achieved by way of the invention described hereinafter.

### SUMMARY OF THE INVENTION

A herbicidal combination comprising (a) carfentrazone ethyl; (b) an organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin and their salts and esters; and (c) an imidazolinone herbicide selected from imazamethabenz, imazamox, imazapic, imazapyr, imazaquin, imazethapyr and their salts and esters.

A method of controlling weeds at a locus, the method comprising applying, to the locus, a combination comprising a) carfentrazone ethyl; (b) an organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin and their salts and esters; and (c) an imidazolinone herbicide selected from imazamethabenz, imazamox, imazapic, imazapyr, imazaquin, imazethapyr and their salts and esters.

A composition comprising a) carfentrazone ethyl; (b) an organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin and their salts and esters; and (c) an imidazolinone herbicide selected from imazamethabenz, imazamox, imazapic, imazapyr, imazaquin, imazethapyr and their salts and esters; and (d) at least one agrochemically acceptable excipient.

A method of controlling weeds at a locus, said method comprising applying a composition comprising a) carfentrazone ethyl; (b) an organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin and their salts and esters; and (c) an imidazolinone herbicide selected from imazamethabenz, imazamox, imazapic, imazapyr, imazaquin, imazethapyr and their salts and esters; and (d) at least one agrochemically acceptable excipient.

### DETAILED DESCRIPTION OF THE INVENTION

Surprisingly, it has been found by the present inventors that the combination of carfentrazone ethyl, an organophosphorus herbicide and an imidazolinone herbicide results in a synergistic control of undesirable plants at the locus of the desirable crop plants.

The inventors have surprisingly found that the carfentrazone ethyl, when added to the combination of organophosphorus herbicides and imidazolinone herbicides resulted in an unexpected synergy. Without wishing to be bound by theory, it was found that the carfentrazone ethyl, even when added in minute quantities, surprisingly increased the efficacy of the organophosphorus herbicide and the imidazolinone herbicide, causing a synergistic reaction.

The term herbicide, as used herein, shall mean an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, retardation. The terms “plants” and “vegetation” include, but are not limited to, germinant seeds, emerging seedlings, plants emerging from vegetative propagules, and established vegetation. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus.

An aspect of the present invention may be a herbicidal combination comprising (a) carfentrazone ethyl; (b) an organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin and their salts and esters; and (c) an imidazolinone herbicide selected from imazamethabenz, imazamox, imazapic, imazapyr, imazaquin, imazethapyr and their salts and esters;

Another aspect of the present invention may be a method of controlling weeds at a locus, the method comprising applying, to the locus, a combination comprising (a) carfentrazone ethyl; (b) an organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin and their salts and esters; and (c) an imidazolinone herbicide selected from imazamethabenz, imazamox, imazapic, imazapyr, imazaquin, imazethapyr and their salts and esters;

Another aspect of the present invention may be a composition comprising (a) carfentrazone ethyl; (b) an organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin and their salts and esters; and (c) an imidazolinone herbicide selected from imazamethabenz, imazamox, imazapic, imazapyr, imazaquin, imazethapyr and their salts and esters; (d) at least one agrochemically acceptable excipient.

Another aspect of the present invention may be a method of controlling weeds at a locus, said method comprising applying a composition comprising (a) carfentrazone ethyl; (b) an organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin and their salts and esters; and (c) an imidazolinone herbicide selected from imazamethabenz, imazamox, imazapic, imazapyr, imazaquin, imazethapyr and their salts and esters; and (d) at least one agrochemically acceptable excipient.

Each of the aspect described above may have one or more embodiments.

In each of these embodiments, apart from carfentrazone ethyl the embodiments may include the preferred organophosphorus herbicide and a preferred imidazolinone herbicide according to the present invention.

Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

In an embodiment, the present invention provides preferred combinations, compositions and methods thereof. The methods of the invention include a method of controlling weeds at a locus by applying to the locus the combination or the composition, or a method of increasing yield in a crop by application of the combination or composition, or a method of improving the plant health by application at the locus of the plant the combination or the composition. The embodiments described herein describe the preferred embodiments of all these possible combinations, compositions and methods of the invention.

Thus, an embodiment of the present invention may be a herbicidal combination comprising (a) carfentrazone ethyl; (b) an organophosphorus herbicide selected from glufosinate, glufosinate-P and glyphosate and their salts and esters; and (c) an imidazolinone herbicide selected from imazamethabenz, imazamox, imazapic, imazapyr, imazaquin, imazethapyr and their salts and esters;

Another embodiment of the present invention may be a herbicidal combination comprising (a) carfentrazone ethyl (b) glufosinate or a salt or ester thereof; and (c) an imidazolinone herbicide selected from imazamethabenz, imazamox, imazapic, imazapyr, imazaquin, imazethapyr and their salts and esters;

Another embodiment of the present invention may be a herbicidal combination comprising (a) carfentrazone ethyl (b) glufosinate ammonium; and (c) an imidazolinone herbicide selected from imazamethabenz, imazamox, imazapic, imazapyr, imazaquin, imazethapyr and their salts and esters;

Another embodiment of the present invention may be a herbicidal combination comprising (a) carfentrazone ethyl (b) glufosinate or a salt or ester thereof; and (c) Imazethapyr or its salts and esters;

Another embodiment of the present invention may be a herbicidal combination comprising (a) carfentrazone; (b) glufosinate-P or a salt or an ester thereof; and (c) imidazolinone herbicide selected from imazamethabenz, imazamox, imazapic, imazapyr, imazaquin, imazethapyr and their salts and esters;

Another embodiment of the present invention may be a herbicidal combination comprising (a) cafentrazone ethyl; (b) glufosinate-P or a salt or an ester thereof; and (c) imazethapyr and its salts and esters;

Another embodiment of the present invention may be a herbicidal combination comprising (a) carfentrazone; (b) glyphosate; and (c) imidazolinone herbicide selected from imazamethabenz, imazamox, imazapic, imazapyr, imazaquin, imazethapyr and their salts and esters;

Another embodiment of the present invention may be a herbicidal combination comprising (a) carfentrazone ethyl; (b) glyphosate; and (c) imazethapyr and its salts and esters;

The combination may be applied to the locus of the weeds in an herbicidally effective amount. The selection of the appropriate effective amounts depends on the density of weed infestation, weather patterns, crop health and many other factors, which may be made conveniently by a person skilled in the art. The effective amounts of these herbicides in the synergistic combination of the present invention is not particularly limiting.

In an embodiment, the combination of the present invention may be combined with at least one other active ingredient selected from the group consisting of herbicides, insecticides, fungicides, biological agents, plant growth activators, fertilizers or combinations thereof.

Thus, in an embodiment, the combination of the present invention may be combined with a herbicide. Exemplary herbicides that may be combined with the combination of the present invention may be selected from, but not limited to, herbicides belonging to classes such as ACCase inhibitors, ALS inhibitors, EPSP synthase inhibitors, synthetic auxins, auxin transport inhibitors, HPPD inhibitors, lipid synthesis inhibitors, long chain fatty acid inhibitors, as well as herbicides with unknown modes of action.

In an embodiment, the total amount of carfentrazone ethyl in the composition may typically be in the range of 0.1 to 99% by weight, preferably 0.2 to 90% by weight. The total amount of the organophosphorus herbicide in the composition may be in the range of 0.1 to 99% by weight. The total amount of the imidazolinone herbicide in the composition may be in the range of 0.1 to 10% by weight.

In an embodiment, the constituent herbicides of the combination of the present invention may be admixed in ratio of (1-80):(1-80):(1-10) of carfentrazone ethyl, the organophosphorus herbicide and the imidazolinone herbicide respectively.

In an aspect, the present invention may provide herbicidal combinations comprising carfentrazone ethyl, glufosinate, imazethapyr and their salts and esters thereof and n herbicidal safener.

In an embodiment, the safener may be selected from benoxacor, BPCMS, cloquintocet, cyometrinil, cyprosulfamide, dichlormid, dicyclonon, dietholate, fenchlorazole, fenclorim, flurazole, fluxofenim, furilazole, isoxadifen, jiecaowan, Jiecaoxi, mefenpyr, mephenate, metcamifen, naphthalic anhydride, oxabetrinil and their salts and esters.

The herbicidal combination of the present invention maybe used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., vines, kaki fruit, olive, plum, banana, oil palm, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

Thus, in another aspect, the present invention provides a method of controlling weeds at a locus, the method comprising applying a combination comprising carfentrazone ethyl, an organophosphorus herbicide and an imidazolinone herbicide to the locus.

Thus, embodiments of the present invention may provide a method of controlling weeds at a locus, said method comprising application of synergistic combination of carfentrazone ethyl, an organophosphorus herbicide and an imidazolinone herbicide and optionally a fourth active ingredient.

In an embodiment, the fourth active ingredient may be selected from herbicide, insecticide, fungicide, biological agent, plant growth activator, fertilizers and combinations thereof.

In an embodiment, the present invention provides a method of controlling weeds at a locus for the burndown of weeds, said method comprising application at the locus of the weed a synergistic combination of carfentrazone ethyl, an organophosphorus herbicide and an imidazolinone herbicide.

The target weeds may be selected from Urticaceae weeds: Urtica urens Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa; Portulacaceae weeds: Portulaca oleracea; Caryophyllaceae weeds: Stellaria media, Cerastium holosteoides, Cerastium glomeratum, Spergula arvensis, Silene gallica Molluginaceae weeds: Mollugo verticillata; Chenopodiaceae weeds: Chenopodium album, Chenopodium ambrosioides, Kochia scoparia, Salsola kali, Atriplex spp.; Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella; Papaveraceae weeds: Papaver rhoeas, Argemone Mexicana; Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus; Dinebra weeds: Dinebra Americana, Dinebra aquatic, Dinebra aristidoides, Dinebra bromoides, Dinebra calycina, Dinebra caudata, Dinebra chinensis, Dinebra chloride, Dinebra chondrosioides, Dinebra coerulescens, Dinebra cristata, Dinebra curtipendula, Dinebra decipiens, Dinebra divaricate, Dinebra divaricatissima, Dinebra dura, Dinebra guineensis, Dinebra hirsute, Dinebra hirta, Dinebra juncifolia, Dinebra ligulata, Dinebra lima, Dinebra melicoides, Dinebra nealleyi, Dinebra neesii, Dinebra panicea, Dinebra panicoides, Dinebra pubescens, Dinebra repens, Dinebra scabra, Dinebra secunda, Dinebra simoniana, Dinebra southwoodii, Dinebra squarrosa, Dinebra srilankensis, Dinebra tuaensis, Dinebra verticillate, Dinebra retroflexa. Dinebra haareri, Dinebra marquisensis, Dinebra perrieri, Dinebra polycarpha, Dinebra somalensis Capparaceae weeds: Cleome affinis; Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis; Oxalidaceae weeds: Oxalis corniculata, Oxalis strica, Oxalis oxyptera; Geraniaceae weeds: Geranium carolinense, Erodium cicutarium; Euphorbiaceae weeds: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis; Malvaceae weeds: Abutilon theophrasti, Sida rhombiforia, Sida cordifolia, Sida spinosa, Sida glaziovii, Sida santaremnensis, Hibiscus trionum, Anoda cristata, Malvastrum coromandelianum Sterculiaceae weeds: Waltheria indica; Violaceae weeds: Viola arvensis, Viola tricolor; Cucurbitaceae weeds: Sicyos angulatus, Echinocystis lobata, Momordica charantia; Lythraceae weeds: Lythrum salicaria; Apiaceae weeds: Hydrocotyle sibthorpioides; Sapindaceae weeds: Cardiospermum halicacabum; Primulaceae weeds: Anagallis arvensis; Asclepiadaceae weeds: Asclepias syriaca, Ampelamus albidus; Rubiaceae weeds: Galium aparine, Galium spurium var. echinospermon, Spermacoce latifolia, Richardia brasiliensis, Borreria alata; Convolvulaceae weeds: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia; Boraginaceae weeds: Myosotis arvensis; Lamiaceae weeds: Lamium purpureum, Lamium amplexicaule, Leonotis nepetaefolia, Hyptis suaveolens, Hyptis lophanta, Leonurus sibiricus, Stachys arvensis; Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides; Scrophulariaceae weeds: Veronica hederaefolia, Veronica persica, Veronica arvensis; Plantaginaceae weeds: Plantago asiatica; Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis; Liliaceae weeds: Allium canadense, Allium vineale; Commelinaceae weeds: Commelina communis, Commelina bengharensis, Commelina erecta; Poaceae weeds: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annus, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis; Cyperaceae weeds: Cyperus microiria, Cyperus iria, Cyperus odoratus, Cyperus rotundus, Cyperus esculentus, Kyllinga gracillima, Equisetaceae weeds: Equisetum arvense, Equisetum palustre, Trianthema weeds and the like.

In an embodiment, the individual components of the combination of the present invention may be applied to the locus either simultaneously or sequentially, such that carfentrazone ethyl, the organophosphorus herbicide and the imidazolinone herbicide may be applied in a tank mix or as a pre-mixed composition.

In an embodiment, combination of the present invention may be applied either pre- or post emergent. In a preferred embodiment, the combination of the present invention may be used pre-emergent, and pre-plant. The advantage of the combination is surprisingly good residual effects, and quick burndown of the weeds when applied pre-plant or pre emergent.

The method of control of the present invention may be carried out by spraying the suggested tank mixes, or the individual herbicides may be formulated as a kit-of-parts containing various components that may be mixed as instructed prior to spraying.

In an embodiment the components of the present invention may be packaged such that carfentrazone ethyl, the organophosphorus herbicide and the imidazolinone herbicide may be packaged separately and then tank mixed before the spraying.

In another embodiment the components of the present invention may be packaged such that carfentrazone ethyl, the organophosphorus herbicide and the imidazolinone herbicide may be packaged separately, whereas other additives are packaged separately, such that the two maybe tank mixed at the time of spraying.

In another embodiment the components of the present invention may be packaged as composition such that the organophosphorus herbicide and the imidazolinone herbicide are formulated into one composition and other additives and carfentrazone ethyl are packaged separately, such that the two maybe tank mixed at the time of spraying.

Therefore, in another aspect, the present invention provides a composition comprising carfentrazone ethyl, the organophosphorus herbicide and the imidazolinone herbicide and at least one agrochemically acceptable excipient.

In an embodiment, the composition of the present invention may contain agriculturally acceptable adjuvants, carriers, diluents, emulsifiers, fillers, anti-foaming agents, thickening agents, anti-freezing agents, freezing agents etc. The compositions may be either solid or liquids. They can be solids, such as, for example, dusts, granules, water-dispersible granules, microcapsules or wettable powders, or liquids, such as, for example, emulsifiable concentrates, solutions, emulsions or suspensions, ZC formulations. They can also be provided as a pre-mix or tank mixes.

Suitable agricultural adjuvants and carriers may include, but are not limited to, crop oil concentrates; methylated seed oils, emulsified methylated seed oil, nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate, urea ammonium nitrate; tridecyl alcohol (synthetic) ethoxylate (8EO); tallow amine ethoxylate; PEG(400) dioleate-99, alkyl sulfates, such as diethanolammonium lauryl sulfate; alkylarylsulfonate salts, such as calcium dodecylbenzenesulfonate; alkylphenol-alkylene oxide addition products, such as nonylphenol-Cm ethoxylate; alcohol-alkylene oxide addition products, such as tridecyl alcohol-Cm ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

Suitable liquid carriers that may be employed in a composition of the present invention may include water or organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide.

Solid carriers that may be employed in the compositions of the present invention may include but are not limited to attapulgite, pyrophyllite clay, silica, kaolin clay, kieselguhr, chalk, diatomaceous earth, lime, calcium carbonate, bentonite clay, Fuller's earth, talc, cottonseed hulls, wheat flour, soybean flour, pumice, wood flour, walnut shell flour, lignin, cellulose etc.

Thus, in another aspect, the present invention provides a method of controlling weeds at a locus, said method comprising applying a composition comprising carfentrazone ethyl, an organophosphorus herbicide and an imidazolinone herbicide and at least one agrochemically acceptable excipient.

Surprisingly, it has been found by the present inventors that carfentrazone ethyl, an organophosphorus herbicide and an imidazolinone herbicide, when applied individually, was ineffective in the control of weeds, but demonstrated excellent synergistic control on weeds when applied together. The combination controlled the weed both pre and post emergently, but was particularly good in the control of burndown weeds. The combination of carfentrazone ethyl, an organophosphorus herbicide and an imidazolinone herbicide synergistically controlled broadleaf weeds, sedges, and grasses a particular locus. The current invention therefore provides advantageous methods of controlling weeds both pre and post emergently. The present method also provides a broader spectrum of controlling weeds that helps in resistance management, thus preventing the weed from becoming resistant to either of the herbicides whist providing a broader spectrum of control at lower use rates.

### EXAMPLES

### Formulation Studies:

The combination of carfentrazone ethyl, an organophosphorus, and an imidazolinone were formulated into agrochemically stable compositions.

### Example 1

A WDG formulation was prepared for the combination of carfentrazone ethyl, glufosinate ammonium and imazathapyr using the following ingredients:

| Composition | Quantity (% w/w) |
|---|---|
| Glufosinate ammonium Technical (96.0% purity) | 20-70 |
| Imazathapyr Technical (98.0% purity) | 5-50 |
| Carfentrazone ethyl Technical (90% purity) | 0.5-10 |
| Adjuvant (Vegetable oil ester) | 1-15 |
| Surfactant (lignosulfonate) | 4-40 |
| Metasperse 550S | 2-5 |
| Antifoaming agent (SAG 1572) | 0.1-1.0 |
| Total | 100 |

A WG formulation was prepared using the composition details provided in the form of Glufosinate-ammonium 400+Imazethapyr 100+Carefntrazone-ethyl 10 g/kg WG formulation. This formulation was prepared using the following process: A required quantity of imazethapyr technical was added into a post-ribbon blender and water was added. An aqueous emulsion was prepared with defoamer and emulsifier (Metasperse) and added to the imazethapyr mixture. To this mixture was added vegetable oil adjuvant and lignosulfonate surfactant, carfentrazone-ethyl and glufosinate-ammonium in required quantities. The resultant mixture was homogenized. The homogenized mixture was charged into plough shear mixture to achieve the required quantity of dough. Water was added, if required. The wet mass was charged into a basket granulator for extrusion. The granules were then dried in a fluid bed dryer. The dried granules were sieved in a sieve shaker to get a homogenous granule size.

### Synergy Studies

Studies were conducted to compare the weed controlling activity of the combination of carfentrazone ethyl, an organophosphorus herbicide and an imidazolinone herbicide. When compared, the observed efficacy with the “expected” efficacy it was found that carfentrazone ethyl and an organophosphorus herbicide such as glufosinate ammonium and imazathapyr showed exceptional synergy. Any difference between the observed and “expected” efficacy could be attributed to synergy between the compounds in the control of a broad spectrum of weeds. The expected efficacy of a combination of carfentrazone, an organophosphorus herbicide and an imidazolinone herbicide was calculated using the well-established Colby method.

In the Colby method, the expected (or predicted) response of a combination of herbicides is calculated by taking the product of the observed response for each individual component of the combination when applied alone divided by 100 and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective. (Colby, S. R., Weeds, 1967(15), p. 20-22) The Colby method requires only a single dose of each herbicide applied alone and the mixture of both doses.

The weed control activity of the individual herbicides of the invention and their combinations were evaluated on weeds such as those belonging to Parthenium hysterophorus, Trianthema monogyna, Dinebra retroflexa, and Cyperus rotundus. The trial was carried out in Randomized Complete Block (RCB) method, all field trials were conducted using this method. Each trial was replicated four times and conducted under GEP guidelines. Application volumes were varied for each mixture. Such field trials were carried out at various locations so as to generate independent data, the locations were chosen randomly across India. Carfentrazone ethyl, glufosinate ammonium and imazethapyr were sprayed according to their recommended dosage.

The following formula was used to calculate the expected activity of mixtures containing three active ingredients, A, B and C:

$$Expected ( E ) A + B + C - \frac{( AB + AC + BC )}{100} + \frac{ABC}{10 \text{,} 000}$$

Where

A=observed efficacy of active ingredient A at the same concentration as used in the mixture.

B=observed efficacy of active ingredient B at the same concentration as used in the mixture.

C=observed efficacy of active ingredient C at the same concentration as used in the mixture.

The above formula was simplified to the following formula to calculate the expected efficacy of the combination:

E=X1Y1Z1/10000

Where, X1 is the growth as a percent-of-control with herbicide A at p lb/A;

Y1 is the growth as a percent-of-control with herbicide B at q lb/A;

Z1 is the growth as a percent-of-control with herbicide C at r lb/A;

E1=expected growth as a percent-of-control with herbicides A+B+C at p+q+r lb/A

The herbicide tank mix combinations, application rates, plant species tested, and results are given in the following tables:

TABLE 1
Table 1 demonstrates synergy on weeds using the combination of carfentrazone
ethyl, glufosinate ammonium and imazethapyr. The field trials were carried out
in India at various locations. The percentage efficacy was calculated after 5 days
of applications. The target weeds were Parthenium hysterophorus and Trianthema monogyna
and the results are recorded in the tables 1 below:

| | | % Weed control Burn Down Symptoms Generation | | | |
|---|---|---|---|---|---|
| | | on different weed species at 5 DAT | | | |
| Dose | | Parthenium hysterophorus | | Trianthema monogyna | |
| Active | Rate Unit | Expected | Actual | Expected | Actual |
| Glufosinate ammonium | 400 gm/ha | | 30 | | 25 |
| Carfentrazone | 10 gm/ha | | 5 | | 70 |
| Imazethapyr | 100 gm/ha | | 5 | | 10 |
| Glufosinate + Carfentrazone + | | 36.8 | 80 | 78.7 | 90 |
| Imazethapyr (400 + | | | | | |
| 10 + 100) | | | | | |

| | | |
|---|---|---|
| Observed − Expected | 43.2 | 11.3 |
| efficacy | | |

The results in table 1 clearly demonstrates synergy between carfentrazone ethyl, glufosinate ammonium and imazathapyr in weeds. The large difference between the observed and the expected efficacy clearly demonstrates the synergistic effect of the combination,

TABLE 2
Table 2 demonstrates synergy on weeds using the combination of carfentrazone
ethyl, glufosinate ammonium and imazethapyr. The field trials were carried
out in India at various locations. The percentage efficacy was calculated after 5
days of applications. The target weeds were Dinebra retroflexa and Trianthema monogyna
and the results are recorded in the tables 2 below:

| | | % Weed control Burn Down Symptoms Generation | | | |
|---|---|---|---|---|---|
| | | on different weed species at 5 DAT | | | |
| Dose | | Dinebra retroflexa | | Cyprus spp | |
| Active | Rate Unit | Expected | Actual | Expected | Actual |
| Glufosinate ammonium | 400 gm/ha | | 15 | | 5 |
| Carfentrazone | 10 gm/ha | | 0 | | 60 |
| Imazethapyr | 100 gm/ha | | 0 | | 00 |
| Glufosinate + Carfentrazone + | | 15 | 85 | 62.5 | 95 |
| Imazethapyr | | | | | |

| | | |
|---|---|---|
| Observed − Expected | 70 | 32.5 |
| efficacy | | |

The results in table 2 clearly demonstrates synergy between carfentrazone ethyl, glufosinate ammonium and imazathapyr in controlling various weeds. The large difference between the observed and the expected efficacy clearly demonstrates the synergistic effect of the combination. In the case Dinebra retroflexa, glufosinate was the only active that controlled the weed. However, the combined combination showed an 85% efficacy in the control of the weed showing a distinct synergy of the combination.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. An herbicidal combination comprising:
a) carfentrazone ethyl;
b) an organophosphorus herbicide; and
c) an imidazolinone herbicide.

2. The herbicidal combination as claimed in claim 1, wherein the organophosphorus herbicide is selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos, shuangjiaancaolin and a salt or ester thereof.

3. The herbicidal combination as claimed in claim 1, wherein the imidazolinone herbicide is selected from imazamethabenz, imazamox, imazapic, imazapyr, imazaquin, and imazethapyr.

4. The herbicidal combination as claimed in claim 1, comprising carfentrazone ethyl; glufosinate, its a salts or esters, and imazethapyr, its salts or esters.

5. A method of controlling weeds at a locus, the method comprising applying the combination according to claim 1 to the locus.

6. A composition comprising carfentrazone ethyl, an organophosphorus herbicide, an imidazolinone herbicide, and at least one agrochemically acceptable excipient.

7. The composition as claimed in claim 6, wherein the composition is in the form of a solid or liquid.

8. The composition as claimed in claim 7, wherein the solid is in the form of dusts, granules, water-dispersible granules, microcapsules or wettable powders, and the liquid is in the form of emulsifiable concentrates, solutions, emulsions or suspensions, or ZC formulations.
